(19) United States
(12) Patent Application Publication
(10) Pub. No.: US 2025/0001378 A1
(43) Pub. Date: Jan. 2, 2025

(54) Ammonia-Based Photocatalytic Reactor Systems and Methods

(71) Applicant: Syzygy Plasmonics Inc., Houston, TX (US)

(72) Inventors: Suman Khatiwada, Houston, TX (US); Shreya Shah, Houston, TX (US); Syed Ali Gardezi, Houston, TX (US); Jonathan Morris Chapman, Houston, TX (US); Hossein Robatjazi, Houston, TX (US); Morgan Glose, Houston, TX (US)

(73) Assignee: Syzygy Plasmonics Inc., Houston, TX (US)

(21) Appl. No.: 18/704,385

(22) PCT Filed: Oct. 25, 2022
(86) PCT No.: PCT/US2022/047729

§ 371 Date: Apr. 24, 2024

Related U.S. Application Data
(60) Provisional application No. 63/271,337, filed on Oct. 25, 2021.

(51) Int. Cl. B01J 8/02; B01D 45/02; B01D 53/047; B01D 53/22; C01B 3/04; C01B 3/50; C01B 3/56

(52) U.S. Cl. CPC B01J 8/0285; B01D 45/02; B01D 53/047; B01D 53/229; B01J 8/0278; C01B 3/047; C01B 3/501; C01B 3/56; B01D 2256/10; B01D 2256/16; B01D 2257/406; B01D 2259/65; B01J 2208/00176; C01B 2203/0405; C01B 2203/042; C01B 2203/0465; C01B 2203/0833; C01B 2203/0883

(57) ABSTRACT

Ammonia-based photocatalytic reactor systems and methods are provided. Example features include coolant-circulation systems utilizing water and/or ammonia as a coolant for removing heat generated by LEDs comprising part of a photocatalytic reactor, a single compressor before the photoreactor inlet compressing ammonia gas anywhere from 1-113.4 Bar at Room temperature to 132.4 C, eliminating the need for second compressor and a choice for optimized reactor conversion, with temperature and pressure chosen to maintain the gas phase while appropriate for downstream separation, storing ammonia either from −33 C to room temperature and from atmospheric pressure to 113.4 bar, in order to eliminate either a need for one or both downstream compressors and-or a need for storing liquid ammonia at negative temperatures, thereby allowing room temperature storage, elimination of a compressor, condenser and two-phase separator, so that a product stream is provided substantially directly to an ammonia scrubber, thus producing ammonium hydroxide as by product to be use either in house or as a product to consumer, replacing a PSA system with a membrane H2 and N2 separator, eliminating a reactor downstream compressor, condenser, two-phase separator, and scrubber and replacing with two PSA systems, including a first one to separate ammonia as backflush and a second one to separate H2 and N2, including, in one example, a compressor between the first PSA system and the second PSA system, and a PDA reactor with combined membrane separation and substantially only a gas cooler and PSA system downstream from the PDA reactor, thereby eliminating a plurality of downstream components such as one or more compressors, condensers, separators, scrubbers, and/or dryers, for example.

### RELATED APPLICATIONS

This International Application claims the benefit of U.S. Provisional Patent Application No. 63/271,337, filed on Oct. 25, 2021, and also incorporates by reference the entirety of U.S. Provisional Patent Application No. 63/271,337, including, in particular, the features illustrated in the color drawings as filed in that application.

### FIELD

This disclosure relates to the field of industrial chemical production, and, in particular, to ammonia-based photocatalytic reactor systems and methods.

### BACKGROUND

Photocatalytic reactors (also referred to herein as a “photoreactors”), such as those developed by Syzygy Plasmonics Inc., can include light emitting diodes (LEDs) to enable photocatalysis and conversion of chemicals. These LEDs convert electrical energy to light energy and heat energy. While the light energy is utilized by the photocatalyst, the heat energy is typically considered a waste and needs to be removed constantly to maintain the temperature of the LEDs below a specified LED operating temperature, such as around 1000, for example.

Needed are improved ammonia-based photocatalytic reactor systems and methods, including improved LED cooling mechanisms for such photocatalytic reactor systems and methods.

### SUMMARY

One embodiment set forth herein is directed to a system that includes an ammonia-decomposition photocatalytic reactor and a coolant circulation system utilizing liquid ammonia as a coolant for cooling LEDs in the photocatalytic reactor, where the liquid ammonia is recovered from a product stream from the photocatalytic reactor.

Another embodiment set forth herein is directed to a system that includes an ammonia-decomposition photocatalytic reactor and a coolant circulation system utilizing water as a coolant to cool LEDs in the photocatalytic reactor, where heat energy is removed from the coolant via chilled liquid ammonia.

Some disclosed embodiments may include only a single compressor positioned in a feed stream prior to an inlet of the photocatalytic reactor, the compressor compressing ammonia gas to a pressure ranging approximately from 1 Bar to a critical pressure of 113.4 Bar at a temperature ranging approximately from 20 C to a critical temperature of 132.4 C, thereby eliminating the need for second compressor.

Some disclosed embodiments may include a single-walled tank for storing feed ammonia at an elevated temperature and an elevated pressure, the elevated temperature being in a range that includes ambient temperature at its upper end, the elevated pressure being up to a critical pressure of 113.4 bar, the elevated temperature and elevated pressure thereby eliminating a need for chilling of a circulating coolant used to cool LEDs in the photoreactor, the elevated temperature and elevated pressure also thereby eliminating a need for the tank to be double-walled, the elevated temperature and elevated pressure causing a decreased amount of ammonia vapor to be generated in the tank to thereby reduce a compressor duty, which allows for an overhead compression system to be omitted from the system.

Some disclosed embodiments may include a multi-stage compressor with inter-stage cooling positioned in the product stream after the photoreactor.

Some disclosed embodiments may include a tank for storing feed ammonia at a temperature range of approximately −33 C to 20 C and at a pressure ranging approximately from atmospheric pressure to a critical pressure of 113.4 bar to eliminate a need for one or both downstream compressors, where the feed ammonia is fed to the photocatalytic reactor.

Some disclosed embodiments may include a photocatalytic reactor product stream that is provided directly to an ammonia scrubber, without being acted on by a compressor, a condenser, or a two-phase separator, to thereby produce ammonium hydroxide as a by-product to ammonia-decomposition.

Some disclosed embodiments may include an ammonia scrubber to directly receive a product stream from the photocatalytic reactor, without applying any compressor, condenser, or scrubber, to thereby produce ammonium hydroxide as a by-product.

Some disclosed embodiments may include a pressure swing adsorber (PSA) system at an output of the system.

Some disclosed embodiments may include a membrane H2 and N2 separator at an output of the system.

Some disclosed embodiments may include a first pressure swing adsorber (PSA) system to separate ammonia as backflush and a second PSA system to separate H2 and N2.

For example, the first and second PSA systems may replace a compressor, a condenser, a two-phase separator, and an ammonia scrubber. In another example, a compressor is provided between the first PSA system and the second PSA system.

Another embodiment set forth herein is directed to a method for cooling a plurality of LEDs in an ammonia-decomposition photocatalytic reactor system. The method includes circulating liquid ammonia proximate the plurality of LEDs to remove heat generated by the plurality of LEDs, where the liquid ammonia is recovered from a product stream from the photocatalytic reactor.

Yet another embodiment set forth herein is directed to a method for cooling a plurality of LEDs in an ammonia-decomposition photocatalytic reactor system. The method includes circulating water in proximity to the plurality of LEDs to remove heat generated by the plurality of LEDs.

Some disclosed embodiments may include storing feed ammonia at a temperature range of approximately −33 C to 20 C and at a pressure ranging approximately from atmospheric pressure to a critical pressure of 113.4 bar, to thereby eliminate a need for one or both downstream compressors, where the feed ammonia is fed to the photocatalytic reactor.

Some disclosed embodiments may include separating a product stream from the photocatalytic reactor via a membrane H2 and N2 separator to thereby produce separate H2 and N2 product streams.

Another embodiment set forth herein is directed to a photocatalytic ammonia-decomposition reactor system that includes a membrane separator at a product stream outlet of the reactor system, a product stream gas cooler, and a PSA system for separating ammonia and nitrogen.

Yet another embodiment set forth herein is directed to a photocatalytic reactor system that includes a photocatalytic ammonia-decomposition (P-DA) reactor having a plurality of LEDs to catalyze an ammonia decomposition reaction in which a feed ammonia stream is converted into a product gas comprising hydrogen, nitrogen, and unconverted ammonia. The plurality of LEDs are cooled by a cooling block heat exchanger through which a coolant is circulated. The system further includes an ammonia tank storing liquid ammonia at atmospheric pressure, the tank supplying the feed ammonia stream to the P-DA reactor, where the feed ammonia stream supplied by the tank is vaporized using the heat energy from the coolant so that the feed ammonia stream is supplied to the P-DA reactor in a gaseous state. The system further includes a turboexpander to cool the product gas from the P-DA reactor after the product gas has been compressed and cooled via an ammonia recycle loop that includes the ammonia tank, an ammonia cooler, a first ammonia condenser, and a recycle compressor. The system further includes a second ammonia condenser to reduce the product gas cooled by the turboexpander, a preheater to heat the reduced product gas by removing heat energy from the coolant circulating through the cooling block heat exchanger, and a PSA system that receives the heated product gas from the preheater and outputs hydrogen and a tail gas comprising a mixture of unrecovered hydrogen and nitrogen. The coolant may be water in some example embodiments.

Some embodiments further include a plurality of knockout separators to remove liquid ammonia from the product gas, where the liquid ammonia is returned to the ammonia recycle loop.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

The accompanying drawings are included to provide a further understanding of the systems, apparatus, devices, and/or methods of the disclosure, and are incorporated in and constitute a part of this specification. The drawings are not necessarily to scale, and sizes of various elements may be distorted for clarity and/or illustrated as simplistic representations to promote comprehension. The drawings illustrate one or more embodiments of the disclosure, and together with the description, serve to explain the principles and operation of the disclosure.

This International Application specifically incorporates by reference the features illustrated in color in the color drawings as filed in U.S. Provisional Patent Application No. 63/271,337. While not necessarily required for a thorough understanding of Applicant's claimed invention, the aforementioned coloring may serve as a helpful supplement to the black-and-white drawings and accompanying specification text.

FIG. 1 is process flow diagram illustrating an ammonia-based photocatalytic reactor system, according to a first example embodiment.

FIG. 2 is a process flow diagram illustrating an ammonia-based photocatalytic reactor system, according to a second example embodiment.

FIG. 3 is a cross-sectional diagram illustrating two cooling block geometries, according to example embodiments.

FIG. 4 is a phase diagram illustrating an example temperature-pressure design zone for an ammonia-based photocatalytic reactor system, according to at least one example embodiment.

FIG. 5 is a phase change diagram illustrating an example simulated phase transition between two phases as a function of temperature.

FIG. 6 is a color-gradient diagram illustrating modeled temperature field simulation results and mass fraction simulation results, according to an example embodiment utilizing an ammonia cooling block.

FIG. 7 is a process flow diagram illustrating an ammonia-based photocatalytic reactor system, according to a third example embodiment.

### DETAILED DESCRIPTION

Example systems, apparatus, devices, and/or methods are described herein. It should be understood that the word “example” is used to mean “serving as an example, instance, or illustration.” Any embodiment or feature described herein as being an “example” is not necessarily to be construed as preferred or advantageous over other embodiments or features unless stated as such. Thus, other embodiments can be utilized, and other changes can be made, without departing from the scope of the subject matter presented herein. The aspects described herein are not limited to specific embodiments, apparatus, or configurations, and as such can, of course, vary. It should be readily understood that the aspects of the present disclosure, as generally described herein, and illustrated in the figures, can be arranged, substituted, combined, separated, and designed in a wide variety of different configurations. It is also to be understood that the terminology used herein is for the purpose of describing particular aspects only, and unless specifically defined herein, is not intended to be limiting.

Throughout this specification, unless the context requires otherwise, the words “comprise” and “include” and variations (e.g., “comprises,” “comprising,” “includes,” “including,” “has,” and “having”) will be understood to imply the inclusion of a stated component, feature, element, or step or group of components, features, elements, or steps, but not the exclusion of any other component, feature, element, or step or group of components, features, elements, or steps.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

As used in the specification and the appended claims, the singular forms “a,” “an,” and “the” include plural referents unless the context clearly dictates otherwise.

Ranges can be expressed herein as from “about” one particular value and/or to “about” another particular value. When such a range is expressed, another aspect includes from the one particular value and/or to the other particular value. Similarly, when values are expressed as approximations by use of the antecedent “about,” it will be understood that the particular value forms another aspect. It will be further understood that the endpoints of each of the ranges are significant both in relation to the other endpoint and independently of the other endpoint.

Any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. OVERVIEW

One LED cooling mechanism that can be utilized for a photocatalytic reactor system is a water-cooled LED heat exchanger. Such a heat exchanger, which may be in the form of a cooling block, for example, can be configured to remove heat energy generated at the LEDs. During this heat-removal process, the inflowing water increases in temperature as it passes through (removing heat generated by the LEDs) and exits the LED heat exchanger. In a system with a complete balance-of-plant, the energy contained in this heated water can be used elsewhere in the plant to improve overall energy efficiency of the plant or system.

In addition to water, the same principle can be applied to other cooling fluids, such as liquid ammonia. In particular, using liquid ammonia in the LED heat exchanger creates new opportunities for process design with novel waste heat-management routes and techniques.

These heat-management routes and techniques may be utilized in ammonia-based photocatalytic reactor systems, including in plants that use ammonia as feed (or process gas), such as in ammonia splitting (i.e., photocatalytic decomposition of ammonia), or in plants that produce ammonia as a product (such as in photocatalytic ammonia synthesis), for example.

Several example ammonia-based photocatalytic reactor systems and methods are set forth. Example features for such systems and methods include one or more of the following: (1) coolant-circulation systems utilizing water and/or ammonia as a coolant for removing heat generated by LEDs comprising part of a photocatalytic reactor, (2) a single compressor before the photoreactor inlet compressing ammonia gas anywhere from 1-113.4 Bar (ammonia's critical pressure) at room temperature (e.g., around 20 C) to 132.4 C (the ammonia's critical temperature), eliminating the need for second compressor and providing opportunities for optimized reactor conversion (i.e., temperature and pressure are chosen to maintain the gas phase while appropriate for downstream separation), (3) storing ammonia either from −33 C to room temperature and from atmospheric pressure to 113.4 bar (ammonia's critical pressure), in order to eliminate either an otherwise typical need for one or both downstream compressors and/or a need for storing liquid ammonia at negative temperatures, thereby allowing room temperature storage, (4) elimination of a compressor, condenser and two-phase separator, so that a product stream is provided substantially directly to an ammonia scrubber, thus producing ammonium hydroxide as by product to be use either in house or as a consumer product, (5) replacing a Pressure Swing Adsorber (PSA) with a membrane H2 and N2 separator, (6) eliminating a reactor downstream compressor, condenser, two-phase separator, and scrubber and replacing them with two PSA systems, including a first one to separate ammonia as backflush and a second one to separate H2 and N2, including, in one example, a compressor between the first PSA system and the second PSA system, and (7) a PDA reactor (photocatalytic ammonia decomposition reactor) with combined membrane separation and substantially only a gas cooler and PSA system downstream from the PDA reactor, thereby allowing for the elimination of a plurality of downstream components such as one or more compressors, condensers, separators, scrubbers, and/or dryers, for example.

### II. EXAMPLE AMMONIA-BASED PHOTOCATALYTIC REACTOR SYSTEMS

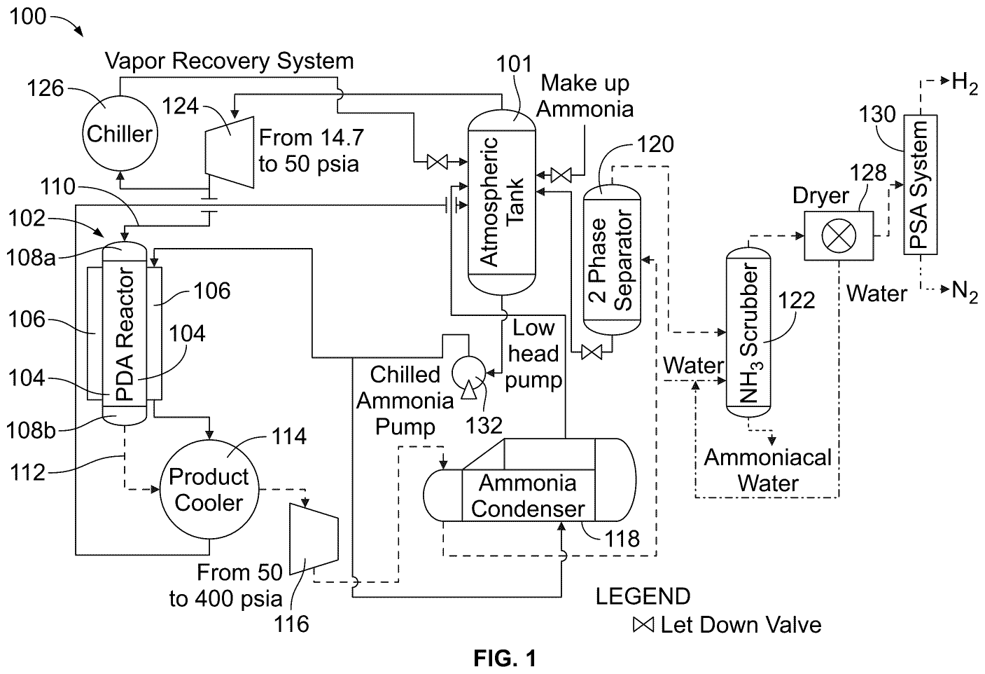

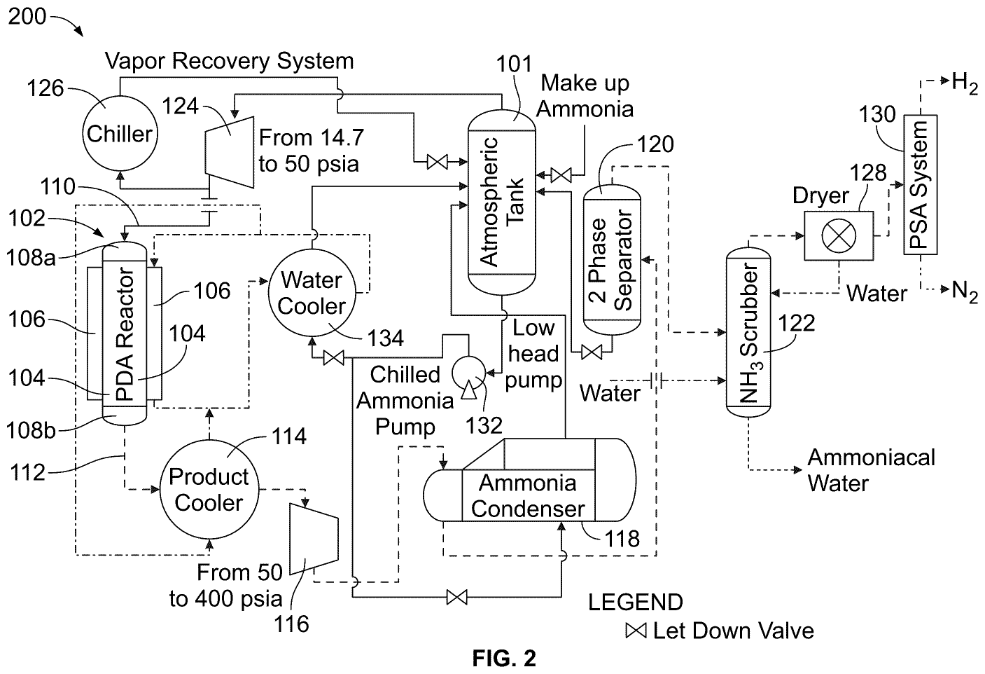

FIGS. 1 and 2 utilize flow lines (routes or paths) that are shown with different patterns to signify general functionality: solid lines (generally in the left-side of FIGS. 1 and 2, including prior to the inlet of photoreactor 102) refer to feed lines, and in the case of system 100 (liquid ammonia-cooled), the ammonia cooling lines; single-dashed lines (generally in the lower-left and upper right of FIGS. 1 and 2) refer to product lines; and lines with alternating dashes and dots refer to utility lines (e.g., water cooling lines). Similarly, in the incorporated U.S. Provisional Application No. 63/271,337, FIGS. 1 and 2 are process flow diagrams in which flow lines (routes) are colored according to the following color scheme: orange-colored lines (generally in the left-side of FIGS. 1 and 2, including prior to the inlet of photoreactor 102) refer to feed lines, and in the case of system 100 (liquid ammonia-cooled), the ammonia cooling lines; green-colored lines (generally in the lower-left and upper right of FIGS. 1 and 2) refer to product lines; and black lines refer to utility lines (e.g., water cooling lines). The functionality of each of these lines is also discernible from the components in the process flow diagrams to which the lines are coupled.

FIG. 1 is a process flow diagram illustrating a liquid-ammonia-cooled photocatalytic reactor system 100, according to a first example embodiment. The system 100 includes an ammonia-decomposition photocatalytic (P-DA) reactor 102 having the following components: a cylindrical or annular reactor cell 104, an annular cooling block 106, and endcaps 108a-b through which feed ammonia 110 enters and a product stream 112 (also referred to as PDA product herein) exits. The example P-DA reactor 102 has the following operating range: 30-100% conversion to suit optimized plant efficiency; 300-6000 temperature range to suit optimized plant efficiency; 15-2000 PSIA (for a rectangular reactor). The P-DA reactor 102 is merely one example reactor configuration, and other shapes, sizes, configurations, phases, and/or other alterations could be made, depending on the particular desired application and operational environment. The following applications provide further description of photoreactors and associated systems, and are hereby incorporated by reference in their entireties: International Application No. PCT/US2018/039470, International Application No. PCT/US2018/039476, International Application No. PCT/US2020/013190, International Application No. PCT/US2020/013206, International Application No. PCT/US2021/042448, and International Application No. PCT/US2022/031444.

The system 100 also includes an atmospheric ammonia tank 101, a product cooler 114, a product compressor 116, an ammonia condenser 118, a two-phase separator 120, a NH₃ scrubber 122, a vapor recovery compressor 124, a vapor recovery chiller 126, a dryer cooler 128, a Pressure Swing Adsorber (PSA) system 130, and a chilled ammonia pump 132, some or all of which are described in further detail herein. In the illustrated example of system 100, the atmospheric ammonia tank 101 and ammonia condenser 118 have the following operating range: 15-2000 PSIA at a temperature range of −33 C to room temperature.

In the system 100, the P-DA reactor 102 is cooled with liquid ammonia. The following discussion assumes an ammonia decomposition plant configured to produce 5 kg-H₂/day.

The product stream 112 from the P-DA reactor 102 does not typically constitute pure components, but rather is a tertiary system (N₂+H₂+NH₃). Therefore, the dew point of ammonia in such a system depends on (i) the concentration of ammonia in the product stream and (ii) the pressure of the system. Low pressure depresses the dew point of ammonia, while high pressure increases the dew point. Thus, for practical purposes, it is recommended to pressurize the PDA product so that ammonia will be condensed under practically achievable conditions. To reduce the work of compression, it is recommended to reduce the PDA product temperature from 4000 to approximately 35 C in the product cooler 114 (e.g., a water cooler), such as one having a cooling duty of approximately 0.5 kW, for example. The product compressor 116 increases the pressure of the PDA product, such as from 50 PSIA to 400 PSIA, for example. The compression product from the product compressor 116 is directly sent to the ammonia condenser 118. Because of the high pressure imparted by the product compressor 116, it is possible to condense approximately 95% of ammonia (in the PDA product) by evaporating pure ammonia, at atmospheric pressure and at saturation temperature (−32 C), inside a shell side of the ammonia condenser 118.

The condensed ammonia from the ammonia condenser 118 is recovered in the two-phase separator 120, while the left-over trace ammonia amount is separated in the scrubber 122. Water at near ambient condition is used for scrubbing, according to one example. A flow rate of 5 kg/hr water has been found to be efficient to heat-up the incoming scrubber gaseous feed from −32 C to approximately 30 C to 35 C, which is suitable for a subsequent PSA system operation. Ammonia dissolves and reacts with water to form NH3+H2 O in an exothermic reaction, while some heat is released that equilibrates the system at 30 C to 35 C. Liquid ammonia from the two-phase separator 120 is routed to the atmospheric tank 101, which acts as a main reservoir of ammonia. The pressure inside the atmospheric tank 101 is kept at nearly atmospheric conditions by exporting the overhead vapors to a recovery system. The vapor recovery system uses (i) the vapor recovery compressor 124, which compresses vapors to near 50 PSIA, while during compression, the adiabatic temperature rise is expected to be approximately 70 C-75 C, and (ii) the vapor recovery chiller system 126 to liquify the vapors, for sending them back to the PDA reactor 102. Further, a portion of the compressed vapors is fed to the reactor as feed ammonia 110, while a steady supply of feed liquid is maintained at the reservoir.

LED cooling for the P-DA reactor 102 is via a chilled liquid ammonia circulation circuit. The chilled ammonia pump 132 receives ammonia from the atmospheric ammonia tank 101 and provides the chilled liquid ammonia to the cooling block 106 of the P-DA reactor 102. The chilled liquid ammonia in the cooling block 106 absorbs heat from the LEDs in the P-DA reactor 102, and the heated ammonia is fed to the product cooler 114 along with the product stream 112, wherein it continues in the same route as the product stream 112 (i.e., through the compressor 116, ammonia condenser 118, etc.). Note that the dryer cooler 128 is only cooling off any exothermic heat that is generated in the scrubber 120 and does not otherwise act as a heat sink.

Liquid ammonia (Cp=80.8 J/mol/K) has a slightly higher heat capacity compared to water (Cp=75.38 J/mol/K) and hence can act as an efficient fluid for extracting waste heat generated at the LEDs. The system 100 set forth in FIG. 1, in addition to cooling with recycled liquid ammonia, additionally produces ammonia gas which can be fed to the P-DA reactor 102 as feed 110. This can result in improved reactor energy efficiency over an unoptimized photocatalytic reactor.

For a photoreactor system like the reactor system 100 illustrated in FIG. 1, but without ammonia recycling, reactor efficiency (liquid ammonia cooling): =(Heat energy generated at LEDs+Energy stored in hydrogen produced (using Lower Heating Value (LHV))) /(Light Energy In+Heat Energy In+Energy in as ammonia (both reacted and unreacted). This can be represented as (Wall power*driver efficiency*(1-LED efficiency)+Hydrogen produced in g*LHV)/(Light Energy In+Heat Energy In+Energy in as ammonia (both reacted and unreacted)). Substituting in example values gives the following efficiency result for a reactor system cooled with liquid ammonia without ammonia recycling: (0.25*0.88*3487+0.33*0.88*4029+6385)/(3487+4029+7995)=(767+1170+6385)/15511=8322/15511=53.6%.

For a photoreactor system like the reactor system 100 illustrated in FIG. 1, with ammonia recycling, reactor efficiency (liquid ammonia cooling+ammonia recycling): =(Heat energy generated at LEDs+Energy stored in hydrogen produced (using LHV))/(Light Energy In+Heat Energy In+Energy in as ammonia (reacted)). This can be represented as (Wall power*driver efficiency*(1-LED efficiency)+Hydrogen produced in g*LHV)/(Light Energy In +Heat Energy In+ammonia conversion*ammonia energy in). Substituting in example values gives the following efficiency result for a reactor system cooled with liquid ammonia and with ammonia recycling=(0.25*0.88*3487+0.33*0.88*4029+6385)/(3487+4029+0.67*7995)=(767+1170+6385)/12873=8322/12873=64.7%.

For a reactor system utilizing both LEDs and IR lamps (e.g., IR lamps inside an annulus of the reactor cell 104 or immersed in a reactor bed of the reactor cell 104 (See, e.g., Applicant's International Application No. PCT/US2022/031444)), the reactor efficiency has been calculated to improve from 55.5% to 57.3% with the use of liquid ammonia for LED cooling (without ammonia recycling) and increases to 66.7% when ammonia recycling is also incorporated. Using the expressions set forth in the previous paragraphs, the calculated efficiency for a photoreactor system utilizing both LEDs and IR lamps is as follows: (1) reactor efficiency (liquid ammonia cooling without ammonia recycling)=(0.25*0.88*1013+7174)/(1013+3892+7995)=7397/12900=57.26%; (2) reactor efficiency (liquid ammonia cooling with ammonia recycling)=(0.25*0.88*1013+7174)/(1013+3892+0.78*7995)=7397/11141=66.4%.

FIG. 2 is a process flow diagram illustrating an ammonia-based photocatalytic reactor system 200, according to a second example embodiment. The system 200 includes the ammonia-decomposition photocatalytic (P-DA) reactor 102 illustrated in FIG. 1, along with its components, which may be the same or similar for both system 100 and system 200. Likewise, many of the other components illustrated in the system 200 of FIG. 2 are similar or identical to those illustrated in the system 100 of FIG. 1 and accordingly have been numbered identically in both figures. The description associated with FIG. 1 of each individual component is incorporated by reference for identically numbered components in FIG. 2, except as otherwise indicated. The system 200 is designed for an ammonia decomposition plant configured to produce 5 kg-H₂/day, with a reactor operating range characterized as follows: 30-100% conversion to suit optimized plant efficiency, 300-6000 temperature range to suit optimized plant efficiency, and 15-2000 PSIA (for a rectangular reactor). Ammonia storage tank and condenser have an operating range of 15-2000 PSIA at a temperature range of −33 C to room temperature.

In the embodiment of FIG. 2, the P-DA reactor 102 is cooled by a closed-loop water circuit, as illustrated. The hot water heated by the LEDs in the P-DA reactor 102 combines with the hot water used for cooling the PDA reactor product. This combined hot stream is cooled using a saturated ammonia stream in the water cooler 134 at atmospheric pressure, for example. The ammonia liquid/vapor mixture is sent to the atmospheric ammonia tank 101. The overall process has only one major heat sink, which is the chiller 126. The dryer cooler 128 is only cooling off any exothermic heat that is generated in the scrubber and does not otherwise act as a heat sink.

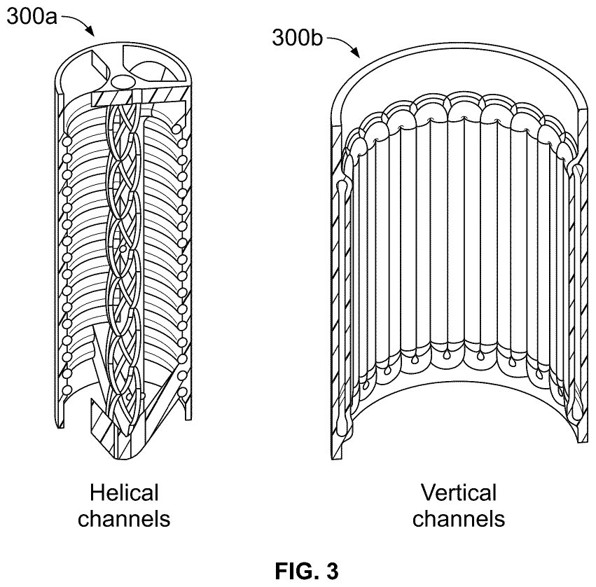

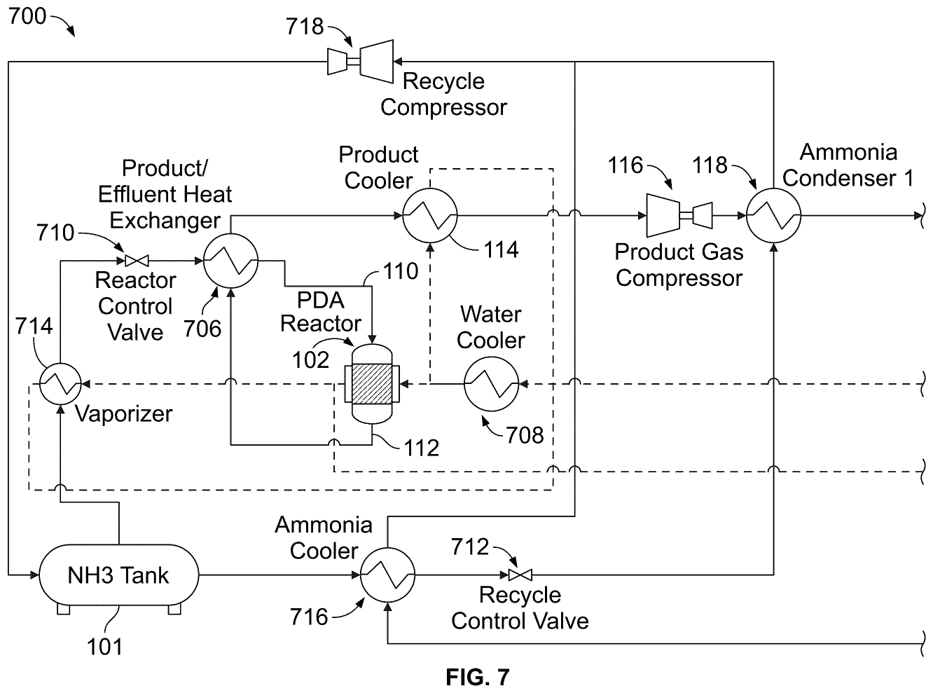

FIG. 3 is a cross-sectional diagram illustrating two cooling block geometries, according to example embodiments used for modeling and simulation (see the following discussion and FIG. 6, directed to a helical channel implementation similar to geometry 300a). Either of the illustrated cooling block geometries 300a and 300b may be used as components in a heat exchanger in the systems 100 and 200 shown in FIGS. 1 and 2, such as in a photoreactor cell having a cylindrical or annular shape, for example. In particular, cooling block geometry 300a or 300b may allow a cooling block 106 to be placed in close proximity to an LED array in the reactor 102, so that circulating coolant (e.g., water or ammonia) may remove heat generated by the LEDs. Cooling block geometry 300a is shown as having helical channels wrapping around an inner circumference of a cooling block shell. Cooling block geometry 300b is shown as having vertical channels traversing back and forth vertically along an inner circumference of a cooling block shell. Other cooling block geometries may be used besides those examples illustrated in FIG. 3.

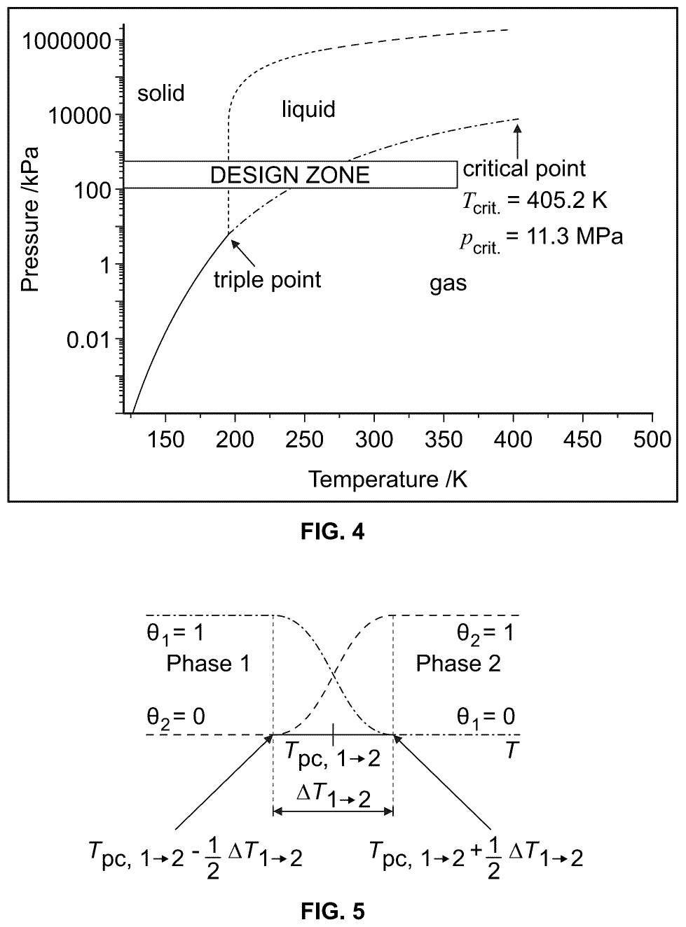

FIG. 4 is a phase diagram illustrating an example temperature-pressure design zone for an ammonia-based photocatalytic reactor system, according to at least one example embodiment.

For the ammonia-based photoreactor designs set forth herein, the following example design parameters apply. First, an inlet pressure of 1-5 bara (absolute pressure) may be utilized so that an increase in pressure gives room for liquid to exchange heat before evaporating. Second, an inlet temperature (just below saturation) may be utilized so that a lower temperature also gives more room for liquid to have good heat exchange.

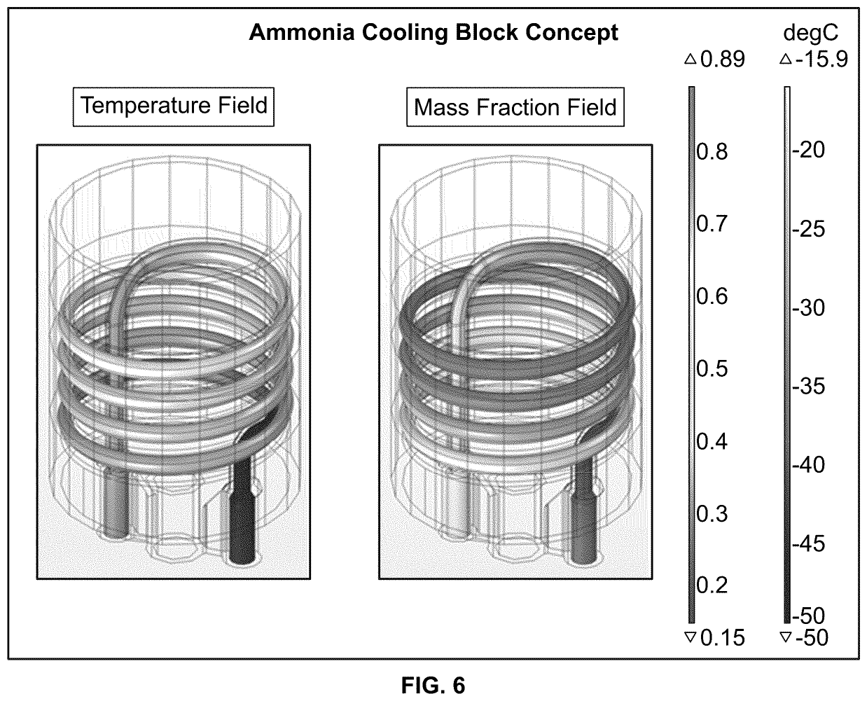

FIG. 5 is a phase change diagram illustrating an example simulated phase transition between two phases as a function of temperature. Simulating phase change in ammonia requires a smooth transition, which is illustrated in FIG. 5. Temperature interval affects smoothness and mesh size required. Effective material properties are calculated based on phase (mass fraction):

$$ρ = {θ}_{1} {ρ}_{1} + {θ}_{2} {ρ}_{2} ; k = {θ}_{1} {k}_{1} + {θ}_{2} {k}_{2} ; {C}_{p} = \frac{1}{ρ} ( {θ}_{1} {C}_{p , 1} + {θ}_{2} {C}_{p , 2} ) + {C}_{L} .$$

Latent heat of phase change (C_{L}) is incorporated into heat capacity instead of as a heat source/sink.

FIG. 6 is a modeling simulation results diagram illustrating temperature field simulation results and mass fraction simulation results, according to an example embodiment utilizing an ammonia cooling block. The shading (or colors) in the simulation results of FIG. 6 illustrate how temperature and mass fraction respectively change as coolant is circulated in a helical bottom-to-top configuration, starting at the bottom right of each illustrated simulation, and exiting (after traversing top-to-bottom through an interior of the helix) at the bottom left of each illustrated simulation. As shown, coolant temperature starts at less than −40 C and heats to as high as around −15 C before exiting, while mass fraction starts at less than 0.3 and exits after reaching a mass fraction approaching 0.89.

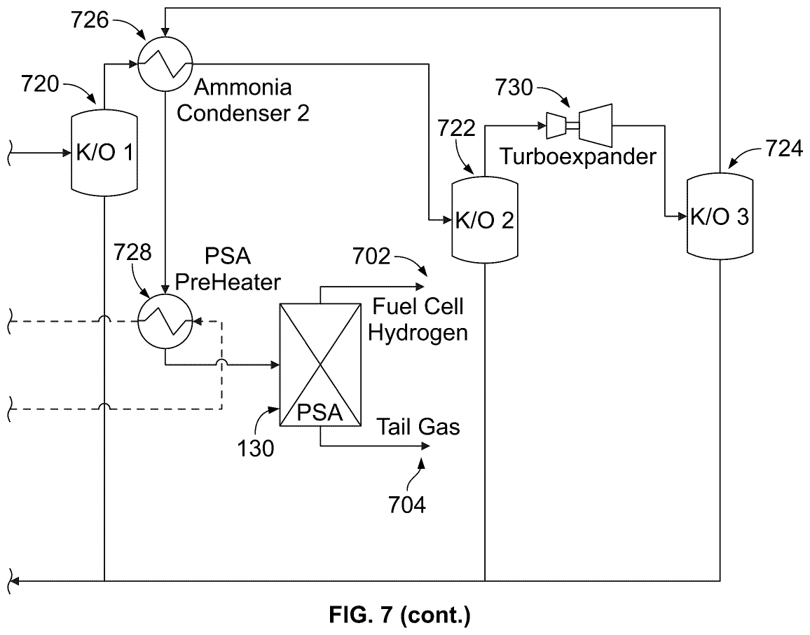

FIG. 7 is a process flow diagram illustrating an ammonia-based photocatalytic reactor system 700, according to a third example embodiment, which differs somewhat from the systems 100 and 200 illustrated respectively in FIGS. 1 and 2. The system 700 includes a P-DA reactor 102, which may be similar or identical to the P-DA reactor 102 described above with respect to FIGS. 1 and 2, for example.

The system 700 also includes an atmospheric ammonia tank 101, a product cooler 114, a product compressor 116, a first ammonia condenser 118, a Pressure Swing Adsorber (PSA) system 130, similar to as described above with respect to the systems 100 and 200. Moreover, similarly numbered components in system 700 may have operating ranges similar or identical to those in the systems 100 and 200, for example. In addition to the aforementioned components, the system 700 additionally includes a product/effluent heat exchanger 706, a water cooler 708, a reactor control valve 710 (for controlling the flow of ammonia to the heat exchanger 706), a recycle control valve 712 (for controlling the flow of cooled ammonia to the first ammonia condenser 118, a vaporizer 714, an ammonia cooler 716, an ammonia recycle compressor 718, a first knockout separator 720, a second knockout separator 722, a third knockout separator 724, a second ammonia condenser 726, a PSA preheater 728, and a turboexpander 730.

The system 700 may be utilized in a plant designed to use the P-DA reactor 102 for converting ammonia feed stock into fuel-cell-grade hydrogen. Feed ammonia 110 is fed into the P-DA reactor 102 and converted into a product stream 112 consisting of hydrogen, nitrogen, and unconverted ammonia. The product stream 112 is cooled via the product cooler 114 using a recycle loop taken from the ammonia tank. The cooled product stream 112 is compressed via the product gas compressor 116. After liquid ammonia is knocked out via the first and second knockout separators 720 and 722, the product gas is cooled further via the outlet of the turboexpander 730 to knockout (via the third knockout separator 724) more liquid ammonia, resulting in an ammonia concentration in the product stream (fed back through the second ammonia condenser 726) of less than 50 ppm. The product gas (output from the second ammonia condenser 726) is then heated via PSA preheater 728 and sent through the PSA system 130 to produce fuel-cell-grade hydrogen 702 and tail gas 704, which is a mixture of unrecovered hydrogen and nitrogen in the illustrated example.

The system 700 differs from other system designs in several respects. First, the system 700 makes use of heat integration of energy removed by LED coolant (e.g., water). Second, the system 700 replaces the ammonia scrubber 122 of systems 100 and 200 with a turboexpander 730. Third, the system 700 eliminates the need for a dedicated vaporizer in or associated with the ammonia tank 101. Each of these distinguishing features will now be described in further detail.

First, the system 700 makes use of heat integration of energy removed by LED coolant (e.g., water). The P-DA reactor 102 uses light generated from LEDs to power the reaction. These LEDs need to be kept cool to operate. To achieve this, LEDs are attached to an in-house-designed water-cooled cooling block/heat exchanger. The water circulating through the cooling blocks removes heat energy from LEDs and in turn gains heat energy. Instead of discarding the heat energy removed by the water, the heat energy is partially utilized for vaporization (via the vaporizer 714) of liquid ammonia feed to the reactor. Furthermore, cold product gas from the outlet of the turboexpander 730 and the third knockout separator 724 is used to cool down the water (fed back to the ammonia cooler 716). This allows for operating without a conventional chiller unit before sending water back to the cooling blocks.

Second, the system 700 replaces the ammonia scrubber 122 of systems 100 and 200 with a turboexpander 730. The unconverted ammonia in the product stream is typically scrubbed from the system using water. In the system 700, the scrubber 122 of systems 100 and 200 is replaced with a turboexpander. This provides at least four potential advantages. The first of these potential advantages is a reduction in the total amount of water needed for the system, since no water is needed to run a scrubber. The second potential advantage is a reduction in waste-generation. Since the turboexpander 730 replaces the scrubber 122, the ammonium hydroxide waste that would otherwise be generated by the scrubber 122 is removed from the system. As a result, the plant does not need to provide for safe storage and disposal of the hazardous ammonium hydroxide waste stream, which reduces costs and provides other potential benefits. The third potential advantage is that cooling the product stream via the turbo expander 730 allows for knocking off low concentration ammonia from the product stream, rendering it to lower than 50 ppm. Finally, the fourth potential advantage is that the cooled product stream is utilized for removing heat from the LED cooling water, thus eliminating the need for a chiller unit for that purpose.

The third distinguishing feature between the system 700 and the systems 100 and 200 is that the system 700 does not require a dedicated vaporizer in or associated with the ammonia tank 101. Conventional ammonia tanks store ammonia under pressure and room temperature so as to store the chemical in liquid form. Liquid ammonia needs to be supplied to the P-DA reactor 102 at higher than atmospheric pressure and temperature in gaseous form. Feed ammonia tanks from other designs are typically connected to a vaporizer to feed reactor gaseous ammonia at needed pressures and temperatures. In the system 700, instead of using a dedicated vaporizer with the ammonia tank 101, the process is integrated such that the water coming from LED cooling blocks is utilized (at vaporizer 714) for ammonia vaporization and is then further integrated with reactor product gas to attain desired reaction pressure and temperatures.

Each of the above plant design changes results in better heat integration, potentially reducing plant capital expenditures and operating expenses. This, in turn, provides a higher plant efficiency and reduces the generation of hazardous waste.

### III. CONCLUSION

The above detailed description sets forth various features and operations of the disclosed systems, apparatus, devices, and/or methods with reference to the accompanying figures. The example embodiments described herein and in the figures are not meant to be limiting, with the true scope being indicated by the following claims. Many modifications and variations can be made without departing from its scope, as will be apparent to those skilled in the art. Functionally equivalent systems, apparatus, devices, and/or methods within the scope of the disclosure, in addition to those described herein, will be apparent to those skilled in the art from the foregoing descriptions. It will be readily understood that the aspects of the present disclosure, as generally described herein, and illustrated in the figures, can be arranged, substituted, combined, separated, and designed in a wide variety of different configurations. Such modifications and variations are intended to fall within the scope of the appended claims. Finally, all publications, patents, and patent applications cited herein are hereby incorporated herein by reference for all purposes.

1. A system, comprising:
an ammonia-decomposition photocatalytic reactor; and
a coolant circulation system utilizing liquid ammonia as a coolant for cooling LEDs in the photocatalytic reactor, wherein the liquid ammonia is recovered from a product stream from the photocatalytic reactor.

2. A system comprising:
an ammonia-decomposition photocatalytic reactor; and
a coolant circulation system utilizing water as a coolant to cool LEDs in the photocatalytic reactor, wherein heat energy is removed from the coolant via chilled liquid ammonia.

3. The systems of claims 1 or 2, comprising only a single compressor positioned in a feed stream prior to an inlet of the photocatalytic reactor, the compressor compressing ammonia gas to a pressure ranging approximately from 1 Bar to a critical pressure of 113.4 Bar at a temperature ranging approximately from 20 C to a critical temperature of 132.4 C, thereby eliminating the need for second compressor.

4. The systems of claims 1 or 2, further comprising a single-walled tank for storing feed ammonia at an elevated temperature and an elevated pressure, the elevated temperature being in a range that includes ambient temperature at its upper end, the elevated pressure being up to a critical pressure of 113.4 bar, the elevated temperature and elevated pressure thereby eliminating a need for chilling of a circulating coolant used to cool LEDs in the photoreactor, the elevated temperature and elevated pressure also thereby eliminating a need for the tank to be double-walled, the elevated temperature and elevated pressure causing a decreased amount of ammonia vapor to be generated in the tank to thereby reduce a compressor duty.

5. The systems of claim 4, wherein the reduced compressor duty allows for omission of an overhead compression system.

6. The systems of claim 5, further comprising a multi-stage compressor with inter-stage cooling positioned in the product stream after the photoreactor.

7. The systems of claims 1 or 2, further comprising a tank for storing feed ammonia at a temperature range of approximately −33 C to 20 C and at a pressure ranging approximately from atmospheric pressure to a critical pressure of 113.4 bar, to thereby eliminate a need for one or both downstream compressors, wherein the feed ammonia is fed to the photocatalytic reactor.

8. The system of claim 1 or 2, wherein a product stream from the photocatalytic reactor is provided directly to an ammonia scrubber, without being acted on by a compressor, a condenser, or a two-phase separator, to thereby produce ammonium hydroxide as a by-product to ammonia-decomposition.

9. The systems of claim 1 or 2, further comprising an ammonia scrubber to directly receive a product stream from the photocatalytic reactor, without applying any compressor, condenser, or scrubber, to thereby produce ammonium hydroxide as a by-product.

10. The systems of claims 1 or 2, further comprising a Pressure Swing Adsorber (PSA) system at an output of the system.

11. The systems of claims 1 or 2, further comprising a membrane H2 and N2 separator at an output of the system.

12. The systems of claim 1 or 2, further comprising:
a first Pressure Swing Adsorber (PSA) system to separate ammonia as backflush; and
a second PSA system to separate H2 and N2.

13. The system of claim 12, wherein the first and second PSA systems are instead of a compressor, a condenser, a two-phase separator, and an ammonia scrubber.

14. The system of claim 12, further comprising a compressor between the first PSA system and the second PSA system.

15. A method for cooling a plurality of LEDs in an ammonia-decomposition photocatalytic reactor system, the method comprising circulating liquid ammonia proximate the plurality of LEDs to remove heat generated by the plurality of LEDs, wherein the liquid ammonia is recovered from a product stream from the photocatalytic reactor.

16. A method for cooling a plurality of LEDs in an ammonia-decomposition photocatalytic reactor system, the method comprising circulating water in proximity to the plurality of LEDs to remove heat generated by the plurality of LEDs.

17. The methods of claims 15 or 16, further comprising storing feed ammonia at a temperature range of approximately −33 C to 20 C and at a pressure ranging approximately from atmospheric pressure to a critical pressure of 113.4 bar, to thereby eliminate a need for one or both downstream compressors, wherein the feed ammonia is fed to the photocatalytic reactor.

18. The methods of claims 15 or 16, further comprising separating a product stream from the photocatalytic reactor via a membrane H2 and N2 separator to thereby produce separate H2 and N2 product streams.

19. A photocatalytic ammonia-decomposition reactor system comprising:
a membrane separator at a product stream outlet of the reactor system;
a product stream gas cooler; and
a Pressure Swing Adsorber (PSA) system for separating ammonia and nitrogen.

20. A photocatalytic reactor system comprising:
a photocatalytic ammonia-decomposition (P-DA) reactor having a plurality of LEDs to catalyze an ammonia decomposition reaction in which a feed ammonia stream is converted into a product gas comprising hydrogen, nitrogen, and unconverted ammonia, the plurality of LEDs being cooled by a cooling block heat exchanger through which a coolant is circulated;
an ammonia tank storing liquid ammonia at atmospheric pressure, the tank supplying the feed ammonia stream to the P-DA reactor, wherein the feed ammonia stream supplied by the tank is vaporized using the heat energy from the coolant so that the feed ammonia stream is supplied to the P-DA reactor in a gaseous state;
a turboexpander to cool the product gas from the P-DA reactor after the product gas has been compressed and cooled via an ammonia recycle loop that includes the ammonia tank, an ammonia cooler, a first ammonia condenser, and a recycle compressor;
a second ammonia condenser to reduce the product gas cooled by the turboexpander;
a preheater to heat the reduced product gas by removing heat energy from the coolant circulating through the cooling block heat exchanger; and
a Pressure Swing Adsorber (PSA) system that receives the heated product gas from the preheater and outputs hydrogen and a tail gas comprising a mixture of unrecovered hydrogen and nitrogen.

21. The photocatalytic reactor system of claim 20, wherein the coolant is water.

22. The photocatalytic reactor system of claims 20 or 21, further comprising a plurality of knockout separators to remove liquid ammonia from the product gas, wherein the liquid ammonia is returned to the ammonia recycle loop.
